(19) United States
(12) Patent Application Publication
(10) Pub. No.: US 2025/0051692 A1
(43) Pub. Date: Feb. 13, 2025

(54) Co-granules, washing and cleaning agents containing them and their use

(71) Applicant: Catexel GmbH, Wiesbaden (DE)

(72) Inventors: Paul Kaufmann, Hochheim (DE); Rolf Ludwig, Ehlhalten (DE); Judith Preuschen, Sörgenloch (DE)

(21) Appl. No.: 18/796,949

(22) Filed: Aug. 7, 2024

(30) Foreign Application Priority Data
Aug. 8, 2023 (DE) 20 2023 001 670.3

(51) Int. Cl. C11D 3/39; C11D 3/10; C11D 3/12; C11D 3/20; C11D 3/22; C11D 3/32; C11D 3/34; C11D 3/37; C11D 17/00; C11D 17/06

(52) U.S. Cl. CPC C11D 3/3935; C11D 3/10; C11D 3/122; C11D 3/2086; C11D 3/225; C11D 3/32; C11D 3/349; C11D 3/3753; C11D 3/3917; C11D 17/0039; C11D 17/0082; C11D 17/06; C11D 2111/12; C11D 2111/14

(57) ABSTRACT

Disclosed are coated or uncoated co-granules comprising the following:
a) 10 to 40% by weight of cyclic sulfonimine,
b) 20 to 60% by weight of bleach activator selected from the group consisting of tetraacetylethylenediamine, decanoyloxybenzoic acid or mixtures thereof,
c) 0.1 to 5% by weight of organic acid in the form of the free acid and/or a salt thereof in partially neutralized form,
d) 1 to 15% by weight of polyvinyl alcohol as a binder,
e) 10 to 25% by weight of desicant selected from the group consisting of alkali metal sulfate, alkali metal carbonate, alkaline earth metal sulfate, alkaline earth metal carbonate, alkaline earth metal oxide, aluminum oxide, hydrates of these compounds or mixtures of two or more thereof,
f) 0 to 0.5% by weight of dye and/or pigment, and
g) 0 to 5% by weight of water,
wherein the percentages relate to the sum of components a) to g) and the sum of components a) to g) is 100 percent.

These co-granules are stable in storage over a longer period of time and contain ingredients which do not tend to discolor during storage or which, in the case of colored co-granules, do not tend to change color.

### CLAIM FOR PRIORITY

This application is a national phase application of DE Application 20 2023 001670.3 filed Aug. 8, 2023, the priority of which is hereby claimed and its disclosure incorporated by reference herein in its entirety.

### FIELD OF THE INVENTION

The present invention relates to co-granules, detergents and cleaning agents for textiles and surfaces and their use for disinfecting and for washing or cleaning at low temperatures.

### BACKGROUND OF THE INVENTION

In order to achieve a bleaching effect, persalts such as perborates and percarbonates are added to washing and cleaning agents. To activate these bleaching agents and to achieve a satisfactory bleaching effect when cleaning at temperatures of 60° C. and below, these agents usually also contain bleach activators and/or bleach catalysts.

Bleach activators and bleaching catalysts are preferably added to detergents and cleaning agents in the form of prefabricated granules. This is done on the one hand to increase their storage stability and on the other hand to ensure homogeneous incorporation of minute amounts of catalyst into the formulations.

Sulfonimines and their use in detergents and cleaning agents have already been described in the patent literature.

DE 691 04 405 T2 corresponding to EP 0 453 003 B1 discloses bleaching compositions for detergents containing 1 to 60% by weight of a peroxygen compound, 0.05 to 10% by weight of a selected sulfonimine and 0.5 to 50% by weight of a surfactant.

In DE 691 04 751 T2 corresponding to EP 0 446 982 B1, bleaching compositions are described which contain 1 to 60% by weight of a peroxygen compound, 0.05 to 10% by weight of a selected sulfonimine and 0.1 to 40% by weight of a bleaching precursor which reacts with the peroxide anion. Bleaching compositions are known from this publication which are already effective at low temperatures. In the examples, combinations of sulfonimine with the bleach activator tetraacetylethylenediamine (TAED) and perborate and their effect on textiles prepared with tea stains are described. The bleaching agent is applied at temperatures of 40° C.

In the SOFW Journal 140 9-2014, G. Reinhardt, M. Best, I. Herrgen and M. Ladwig describe sulfonimines and quaternary iminium salts as novel bleaching catalysts. These compounds serve as precursors of dioxiranes, oxaziridines and oxaziridinium salts, which achieve in combination with per compounds an excellent bleaching effect even in low concentrations. In this publication, it has already been proposed to use sulfonimines and quaternary iminium salts in the form of granules with other bleach activators, such as TAED or nonanoyloxybenzenesulfonate sodium (NOBS), and also to use film-forming binders. However, such granules are often not sufficiently stable in storage.

EP 3,345,989 A1 discloses granules containing sulfonimines or quaternary iminium salts and an acid being solid at 25° C. as a stabilizer. These granules can be used to formulate detergents and cleaning agents which can be used at temperatures below 35° C.

Co-granules containing selected bleach activators and sulfonimines are known from DE 10 2020 001 458 A1. These are co-granules coated with cellulose ether, which contain cyclic sulfonimine, selected bleach activator, for example tetraacetylethylenediamine (TAED) and cellulose ether as a binder. These co-granules can be produced particularly well by wet granulation.

Tests have shown that cellulose ethers, such as carboxymethyl cellulose, as binders in combination with bleach activator, sulfonimine and siccatives, such as calcium sulphate, do not produce stable granules. The addition of siccative appears problematic in this context. In addition, problems arose when dosing powder mixtures of siccative and sulfonimine, as these mixtures adhered to the pipes and remained there. In addition, difficulties were encountered when coloring granules comprising cellulose ether as a binder. Finally, small particles of the granules could only be insufficiently coated and turned yellow to brown when stored in detergent and cleaning agent formulations.

Surprisingly, it was found that these problems could be solved by replacing the cellulose ether binder with polyvinyl alcohol.

In EP 3,345,989 A1, the use of non-acidic binders is generally proposed, whereby polyvinyl alcohol is also mentioned as a binder. In the examples in this document, microcrystalline cellulose was also used as a binder in addition to polyvinyl alcohol. However, the latter does not allow wet granulation. Surprisingly, it was found that stable co-granules can be produced by wet granulation using polyvinyl alcohol as the sole binder. In addition, all the granules described in EP 3,345,989 A1 show a slight yellowish tinge after storage. The co-granules of the present invention show no change in color even after prolonged storage.

### SUMMARY OF THE INVENTION

Based on this prior art, the present invention was based on the objective of providing co-granules which are stable in storage over a longer period of time and which contain larger amounts of highly active bleach activators, bleach catalysts and siccatives which do not tend to discolor during storage or which, in the case of colored co-granules, do not tend to change color.

A further objective of the present invention was to provide additional stable co-granules which contain highly active bleach activators and bleach catalysts and which do not disintegrate back into their powdery components after wet granulation.

These objectives are solved by providing coated or uncoated co-granules comprising
a) 10 to 40% by weight of cyclic sulfonimine,
b) 20 to 60% by weight of bleach activator selected from the group consisting of tetraacetylethylenediamine, decanoyloxybenzoic acid or mixtures thereof,
c) 0.1 to 5% by weight of organic acid in the form of the free acid and/or in the form of a salt thereof,
d) 1 to 15% by weight of polyvinyl alcohol as binder,
e) 10 to 25% by weight of desiccant selected from the group consisting of alkali metal sulfate, alkali metal carbonate, alkaline earth metal sulfate, alkaline earth metal carbonate, alkaline earth metal oxide, aluminum oxide, hydrates of these compounds or mixtures of two or more of these,
f) 0 to 0.5% by weight of dye and/or pigment, and
g) 0 to 5% by weight of water,

where the percentages relate to the sum of components a) to g) and the sum of components a) to g) is 100 percent.

### DETAILED DESCRIPTION OF THE INVENTION

The present invention relates to washing and cleaning agents comprising
A) bleaching agents selected from the group consisting of perborate, percarbonate or mixtures thereof, and
B) the co-granules as described above.

In the washing and cleaning agents according to the invention selected per-compounds are used as component A). These are perborate, percarbonate or mixtures thereof.

Preferably, the corresponding sodium salts of the perborates and percarbonates are used as component A), in particular sodium percarbonate.

The amount of component A) in the washing and cleaning agents according to the invention comprises about is usually 5 to about 30% by weight, based on the total amount of washing and cleaning composition. Preferred amounts of component A) are in the range from about 5 to about 20% by weight, in particular in the range from about 8 to about 12% by weight.

Co-granules with selected components are used as component B) in the detergent and cleaning agents according to the invention. These co-granules are preferably coated with a coating of cellulose ether. These co-granules contain selected amounts of the components a) to g) defined above as ingredients.

The amount of component B) in the detergent and cleaning agents according to the invention comprises about 0.05 to about 10% by weight, based on the total amount of detergent and cleaning agent. Preferred amounts of component B) are in the range from about 0.2 to about 8% by weight, in particular from about 0.5 to about 6% by weight, especially preferred from about 0.5 to about 3% by weight, and most preferably in the range from about 0.5 to about 2% by weight.

The cyclic sulfonimines used according to the invention as component a) are cyclic compounds with a structural unit ═N—SO₂— in the molecule. Cyclic sulfonimines preferably used as component a) are compounds of the formula I

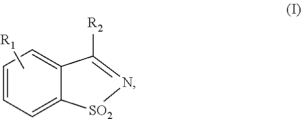

in which R₁ and R₂ independently of one another are hydrogen, C₁-C₆-alkyl or phenyl.

Of the compounds of formula I, particularly preferred are those in which R₁ is hydrogen and R₂ is C₁-C₆-alkyl, in particular methyl or ethyl, or phenyl.

A highly preferred sulfonimine of formula (I) is 3-methyl-1,2-benzisothiazole-1,1-dioxide.

If one of the radicals in this description is C₁-C₆-alkyl, the alkyl group can be either branched or unbranched. An alkyl group contains one to six carbon atoms. Examples of alkyl groups are: Methyl, ethyl, n-propyl, isopropyl, n-butyl, sec-butyl, tert-butyl, pentyl or n-hexyl.

The amount of component a) in the co-granules according to the invention comprises between about 10 and about 40% by weight, based on the total amount of components a) to g) in the co-granules. Preferred amounts of component a) are in the range of about 25 to about 35% by weight, in particular in the range of about 27 to about 33% by weight.

According to the invention, tetraacetylethylenediamine or decanoyl-oxybenzoic acid is used as bleach activator b). Mixtures thereof can also be used. Preferred component b) is tetraacetylethylenediamine.

The amount of component b) in the co-granules according to the invention comprises between about 20 and about 60% by weight, based on the total amount of components a) to g) in the co-granules. Preferred amounts of component b) are in the range from about 20 to about 50% by weight, in particular in the range from about 25 to about 45% by weight, and most preferably in the range from about 30 to about 40% by weight.

Both monomeric and polymeric acids can be used as organic acids c) either in the form of the free acid or in the form of their salts. In the context of the present invention, the term “organic acid” therefore includes both the organic acids in free form and in salt form.

Preferred counterions of organic acids are alkali ions and in particular Na ions.

Preferred organic acids c) comprise citric acid, ascorbic acid, oxalic acid, adipic acid, sebacic acid, malonic acid, succinic acid, glutaric acid, malic acid, tartaric acid, lactic acid, maleic acid, fumaric acid, sugar acids, aminocarboxylic acids, C₈-C₂₂ fatty acids and mixtures thereof. Particularly preferred organic acids comprise oxalic acid, ascorbic acid, citric acid and C₈-C₂₂ fatty acids, for example lauric acid, myristic acid, palmitic acid or stearic acid.

Preferred polymeric organic acids c) comprise polymers of acrylic acid or methacrylic acid and copolymers of acrylic acid with methacrylic acid or copolymers of acrylic acid and/or methacrylic acid with maleic acid.

Particularly preferred components c) comprise citric acid, ascorbic acid and oxalic acid or alkali salts of these acids, most preferably citric acid or an alkali salt thereof.

The amount of component c) in the co-granules according to the invention comprise between about 0.1 and about 5% by weight, based on the total amount of components a) to g) in the co-granules. Preferred amounts of component c) are in the range from about 0.3 to about 0.5% by weight, in particular in the range from about 0.39 to about 0.41% by weight.

According to the invention, polyvinyl alcohol is used as binder d). Mixtures of polyvinyl alcohols can also be used.

To characterize polyvinyl alcohol, the viscosity of a 4% aqueous solution at 25° C. (measured with the Höppler viscometer) is often given instead of the molecular weight. Particularly suitable polyvinyl alcohol d) has a viscosity in aqueous solution at 25° C. of 2 to 60 mPa*s, in particular 5 to 10 mPa*s.

Polyvinyl alcohol is usually produced by saponification of polyvinyl acetate. A particularly preferred polyvinyl alcohol has a degree of saponification of about 70 to about 100 mol %, especially about 80 to about 90 mol %.

Other suitable polyvinyl alcohols d) may have been hydrophobically or hydrophilically modified in some way.

The amount of component d) in the co-granules according to the invention comprises between about 1 and about 15% by weight, based on the total amount of components a) to g) in the co-granules. Preferred amounts of component d) are in the range from about 1 to about 5 wt. %, in particular in the range from about 2 to about 4 wt. %, most preferably in the range from about 3 to about 4 wt. %.

Compounds selected from the group consisting of alkali metal sulfate, alkali metal carbonate, alkaline earth metal sulfate, alkaline earth metal carbonate, alkaline earth metal oxide, aluminum oxide and/or hydrates of these compounds are used as desiccant e). Mixtures of two or more of these can also be used.

Preferably, these compounds are used as hydrates, in particular as dihydrates.

Preferably used desiccants e) are selected from the group consisting of sodium sulfate, magnesium sulfate, calcium sulfate, hydrates of these compounds or mixtures of two or three thereof.

Calcium sulfate, in particular calcium sulfate dihydrate, is particularly preferred as desiccant e).

The amount of component e) in the co-granules according to the invention comprises between about 10 and about 25% by weight, based on the total amount of components a) to g) in the co-granules. Preferred amounts of component e) are in the range of about 15 to about 20% by weight, in particular in the range of about 15 to about 16% by weight.

In addition to the components a) to e) described above, the co-granules according to the invention may also contain dyes and/or pigments f) and/or water g) as further ingredients.

The dyes are coloring compounds which can be dissolved in a solvent, for example in water. Solubility in this context means a solubility at 25° C. of at least 1 g of dye in 1 L of solvent.

The pigments are coloring compounds that cannot be dissolved in a solvent, for example in water, i.e. that have a solubility at 25° C. of less than 1 g of pigment in 1 L of solvent.

The proportion of component f) comprises about 0 to about 0.5% by weight, preferably about 0 to about 0.1% by weight, in particular about 0.03 to about 0.07% by weight, based on the total amount of components a) to g) in the co-granules.

The proportion of component g) comprises about 0 to about 5% by weight, preferably about 0 to about 1% by weight, based on the total amount of components a) to g) in the co-granules.

Other ingredients than components a) to g) and optionally the coating are not present in the co-granules according to the invention.

Preferably, the co-granules according to the invention do not contain any other ingredients in addition to components a) to e), optionally f) and/or optionally the coating.

The co-granules according to the invention can be provided with a coating (so-called coating or protective layer), which further improves the storage stability. In addition, the co-granules can be colored with it; however, it is also possible to formulate dye and/or pigment together with components a) to e).

In the simplest embodiment of the invention, the co-granules according to the invention are not provided with a coating.

In a preferred embodiment of the invention, the co-granules according to the invention are provided with a coating.

Preferred substances for the coating are organic compounds with film-forming properties, such as fatty acids, waxes, polyvinyl alcohols, acetalized polyvinyl alcohols, polyvinylpyrrolidones, polyalkylene glycols, cellulose derivatives, polymeric organic acids, such as polymers of acrylic acid or methacrylic acid and copolymers of acrylic acid with methacrylic acid or copolymers of acrylic acid and/or methacrylic acid with other comonomers, such as maleic acid.

Optionally, the coating may additionally contain small amounts of water-soluble dyes or water-insoluble pigments.

Suitable fatty acids for the coating have 8 to 22 carbon atoms. These are, for example, lauric acid, myristic acid, palmitic acid, stearic acid or mixtures thereof. Organic polymers containing acid groups are also preferred.

The proportion of the coating in the total amount of co-granules can vary over a wide range, but should not exceed about 30% by weight, based on the total mass of the coated co-granules. Preferably, the proportion of the coating comprises about 5 to about 20% by weight, based on the total mass of the coated co-granules.

Preferably, the coating of the co-granules according to the invention is formed from cellulose ethers or contains cellulose ethers.

The cellulose ethers preferably used as coating components are derivatives of cellulose which are formed by partial or complete substitution of the hydrogen atoms of the hydroxyl groups in the cellulose. The type of substituents, the number of substituted hydroxyl groups and their distribution in the cellulose ethers used according to the invention can be varied over a wide range.

Preferably, cellulose ethers that are soluble in water are used. This is understood to mean a solubility of at least 1 g of cellulose ether in 1 L of water at 25° C.

Examples of cellulose ethers that can be used as a coating component are carboxymethyl cellulose (CMC), methyl cellulose (MC), ethyl cellulose (EC), hydroxyethyl cellulose (HEC) or hydroxypropyl cellulose (HPC).

Further examples of cellulose ethers that can be used as a coating component are cellulose mixed ethers, such as methyl ethyl cellulose (MEC), hydroxyethyl methyl cellulose (HEMC), hydroxypropyl methyl cellulose (HPMC), ethyl hydroxy ethyl cellulose or carboxymethyl hydroxy ethyl cellulose

Preferred coating components are HEMC and HPMC.

Optionally, the coating may also contain small amounts of additives, such as organic dyes or pigments, and/or other film-forming polymers. However, the total proportion of such additives and/or other film-forming polymers in the total mass of the coating should not exceed 10% by weight, preferably 5% by weight. Preferably, the coating does not contain any additives, i.e. no dyes or pigments and no other film-forming polymers.

In a further embodiment, the co-granules according to the invention can be provided with two or more coatings, at least one of which consists of cellulose ether. Thus, the co-granules according to the invention can be provided with a first coating, preferably of hydroxypropyl methylcellulose (HPMC) and/or of hydroxyethyl methylcellulose (HEMC), and with a second protective layer, preferably of a fatty acid or a fatty acid mixture, most preferably of stearic acid and palmitic acid.

Co-granules coated with cellulose ether are particularly preferred in terms of their performance and storage stability and, based on the total mass of components a) to g), comprise about 25 to 35 wt. % of component a), 30 to 40 wt. % of component b), 0.3 to 0.5 wt. % of component c), 2 to 4 wt. % of component d), 15 to 20 wt. % of component e), 0.03 to 0.07 wt. % of component f) and 0 to 1 wt. % of component g).

Other particularly preferred co-granules in terms of their performance and storage stability are coated with 5 to 20% by weight of cellulose mixed ethers, in particular with methyl ethyl cellulose (MEC), hydroxyethyl methyl cellulose (HEMC), hydroxypropyl methyl cellulose (HPMC), ethyl hydroxyethyl cellulose or carboxymethyl hydroxyethyl cellulose.

In principle, various pelletizing processes are possible for producing the co-granules according to the invention.

Processes of build-up granulation and degradation granulation can be used. By degradation granulation, the skilled person understands the aggregation of powder by moisture or by pressure followed by degradation by cutting to a desired particle size. Degradation granulation can be carried out as wet or dry granulation.

In the preferred wet granulation process, a dough-like, homogeneous mass is produced from the individual components and a granulating liquid, which is then broken down into granules. Polyvinyl alcohol dissolved in water is used as the granulating liquid. The aqueous solution generally has a polyvinyl alcohol content of between about 10 and about 30% by weight. Polyvinyl alcohol contents of about 15 to about 25% by weight are preferred. These solutions can be sprayed into the pelletizer. The base mass produced is then comminuted to form the co-granules, using aggregates known to the skilled person. A distinction can be made between perforated disk, pressed and shaken granules. Finally, the solvents of the granulating liquids can be removed by heat treatment.

In dry granulation, co-granules are produced by compacting a powder using pressure. Roller compactors, for example, can be used for this purpose. The compacted material produced is then further reduced to the desired size.

In the build-up granulation process, which is also possible, the co-granules are produced directly from powder particles. For example, powder particles can be swirled in an air stream in a fluidized bed and sprayed with a granulating liquid. The powder particles form agglomerates, which are dried by the air flow. Alternatively, co-granules can be produced with high-speed mixers. For this purpose, the components of the co-granule are introduced in powder form at the start of processing. Granulating liquid is added during the process. The high shear forces and friction on the wall of the high-speed mixer produce uniform co-granules.

The fine grain fraction and, if necessary, the coarse grain fraction can be separated by sieving from the co-granules produced. Preferably, the coarse grain fraction is returned to the pelletizer and the fine grain fraction is returned to the compactor.

The co-granules produced in this way are provided with a coating in a separate step, for example in a fluidized bed mixer.

The co-granules according to the invention are primarily characterized by their chemical composition. Nevertheless, it has been shown that the effect of these co-granules can also be advantageously influenced by influencing physical parameters, such as the particle size, the fines content and the bleaching catalyst and bleach activator content of selected sieve fractions.

For this reason, preferred co-granules according to the invention have an average particle size of between about 0.1 and about 1.6 mm, preferably between about 0.2 and about 1.5 mm and particularly preferably between about 0.4 and about 1.2 mm, in each case measured by sieve analysis.

The co-granules according to the invention have a water content of less than about 5% by weight, in particular less than about 2% by weight (measured according to Karl Fischer), based on the total amount of the sum of components a) to g) in the co-granules.

The co-granules are used for the production of the detergents or cleaning agents according to the invention.

The detergents and cleaning agents according to the invention can be present as granules, powder or tablet-like solids, but also in liquid or pasty form in pouches and multi-chamber bottles.

Preferably, the washing and cleaning agents according to the invention are solids in powder or tablet form, in particular powders.

In addition to components A) and B), the washing and cleaning compositions according to the invention may in principle contain all known ingredients which are customary in such compositions.

The washing and cleaning compositions according to the invention, in particular the compositions for cleaning dishes, may in particular contain builder substances, enzymes, alkali carriers, surface-active surfactants, pH regulators, organic solvents and other auxiliary substances, such as glass corrosion inhibitors, silver corrosion inhibitors and foam regulators.

Preferred washing and cleaning agents are in powder form and comprise the following:
i) about 15 to about 65% by weight, preferably about 20 to about 60% by weight, of water-soluble builder component,
ii) about 5 to about 20 wt. %, preferably about 8 to about 15 wt. %, of component A),
iii) about 0.5 to about 6% by weight of co-granules B), and
iv) about 0 to about 65, preferably about 0 to about 50% by weight of other additives, in particular enzymes, alkali carriers, surface-active surfactants, pH regulators, organic solvents or other auxiliaries, such as glass corrosion inhibitors, silver corrosion inhibitors and foam regulators, in each case based on the total weight of the detergent and cleaning agent.

Such an agent is particularly low alkaline, i.e. its 1% by weight solution has a pH value in the range from about 8 to about 11.5 and preferably from about 9 to about 11.

As water-soluble builder components in the washing and cleaning compositions according to the invention, all builders normally used in such compositions can in principle be considered. Examples of these are alkali metal phosphates, which may be present in the form of their alkaline, neutral or acidic sodium or potassium salts, in particular trisodium phosphate, tetrasodium diphosphate, disodium dihydrogen diphosphate, pentasodium triphosphate, so-called sodium hexametaphosphate and the corresponding potassium salts or mixtures of sodium and potassium salts. Their amounts can range from about 15 to about 65% by weight, preferably from about 20 to about 60% by weight, based on the total composition. In addition to polyphosphonates and phosphonate alkyl carboxylates, other possible water-soluble builder components are, for example, organic polymers of native or synthetic origin of the polycarboxylate type, which act as co-builders, particularly in hard water regions.

Examples include polyacrylic acids and copolymers of maleic anhydride and acrylic acid as well as the sodium salts of these polymer acids. Commercially available products are, for example, Sokalan® CP 5, CP 10 and PA 30 from BASF. Polymers of native origin that can be used as co-builders include oxidized starch and polyamino acids such as polyglutamic acid or polyaspartic acid. Other possible water-soluble builder components are naturally occurring hydroxycarbon acids such as mono-, dihydroxy succinic acid, alpha-hydroxypropionic acid and gluconic acid. Preferred organic water-soluble builder components include the salts of citric acid, in particular sodium citrate. Suitable sodium citrate is anhydrous trisodium citrate and preferably trisodium citrate dihydrate. Trisodium citrate dihydrate can be used as a fine or coarse crystalline powder. Depending on the pH value ultimately set in the washing and cleaning compositions according to the invention, in particular the compositions for cleaning dishes, the acids corresponding to the co-builder salts mentioned may also be present. Particularly preferred builder components in phosphate-free formulations are methyl glycine diacetate (MDGA, e.g. Trilon® M, BASF), L-glutamic acid, N,N, (biscarboxymethyl)-tetra sodium salt (GLDA, Dissolvine® DL, Akzo Nobel), sodium polyaspartates (Baypure®, Lanxess) or salts of iminodisuccinic acid (Baypure®, Lanxess).

The enzymes optionally contained in washing and cleaning compositions according to the invention include proteases, amylases, pullulanases, cutinases and/or lipases, for example proteases such as BLAP™, Optimase™, Opticlean™, Maxacal™, Maxapem™, Durazym™, Purafect™ OxP, EXCELLENZ™ P 1250, Esperase™ and/or Savinase™, amylases such as Termamyl™, Amylase-LT™, Maxamyl™, Duramyl™ and/or lipases such as Lipolase™, Lipomax™, Lumafast™ and/or Lipozym™. The enzymes used may be adsorbed on carriers and/or embedded in enveloping substances to protect them against premature inactivation. They are usually contained in the washing and cleaning compositions according to the invention comprising amounts of about 0 to about 10% by weight and preferably in amounts of about 0.05 to about 5% by weight, whereby enzymes stabilized against oxidative degradation are particularly preferred.

Preferably, the washing and cleaning compositions according to the invention contain the usual alkali carriers such as alkali silicates, alkali carbonates and/or alkali hydrogen carbonates. The alkali carriers usually used include carbonates, hydrogen carbonates and alkali silicates with a molar ratio SiO₂/M₂O (M=alkali atom) of about 1:1 to about 2.5:1. Alkali silicates may be present in quantities of up to 40% by weight, in particular from about 3 to about 30% by weight, based on the total weight of the washing and cleaning composition. The alkali carrier system preferably used in the washing and cleaning compositions according to the invention is a mixture of carbonate and hydrogen carbonate, preferably sodium carbonate and sodium hydrogen carbonate, which may be present in an amount of up to 50% by weight and preferably from 5 to 40% by weight.

In a further preferred embodiment of the invention, the washing and cleaning compositions according to the invention contain about 20 to about 60% by weight of water-soluble organic builders, in particular alkali metal citrate, 3 to 20% by weight of alkali metal carbonate and 3 to 40% by weight of alkali metal disilicate.

Surfactants, in particular anionic surfactants, zwitterionic surfactants and preferably low-foaming nonionic surfactants, may also be added to the washing and cleaning compositions according to the invention, which serve to improve the removal of fatty soiling, as wetting agents and optionally as granulation aids in the manufacture of these compositions. Their amount can be up to about 20% by weight, preferably up to about 10% by weight and is particularly preferably in the range of about 0.5 to 5% by weight, based in each case on the total weight of the detergent and cleaning agent.

Extremely low-foaming compounds are usually used. These preferably include C₁₂-C₁₈ alkyl polyethylene glycol polypropylene glycol ethers with up to 8 moles each of ethylene oxide and propylene oxide units in the molecule. However, other known low-foaming nonionic surfactants can also be used, such as C₁₂-C₁₈ alkyl polyethylene glycol polybutylene glycol ethers with up to 8 moles each of ethylene oxide and butylene oxide units in the molecule, end-capped alkyl polyalkylene glycol mixed ethers as well as the foaming but ecologically attractive C₈-C₁₄ alkyl polyglucosides with a degree of polymerization of about 1 to 4 and/or C₁₂-C₁₄ alkyl polyethylene glycols with 3 to 8 ethylene oxide units in the molecule. Also suitable are surfactants from the glucamide family, such as alkyl N-methyl glucamides, in which the alkyl part preferably originates from a fatty alcohol with the C chain length C₆-C₁₄. It is sometimes advantageous if the surfactants described are used as mixtures, for example the combination of alkyl polyglycoside with fatty alcohol ethoxylates or glucamide with alkyl polyglycosides. The presence of amine oxides, betaines and ethoxylated alkylamines is also possible.

In order to set a desired pH value which does not result automatically from the mixture of the other components, the washing and cleaning compositions according to the invention may contain system-compatible and environmentally compatible acids, in particular citric acid, acetic acid, tartaric acid, malic acid, lactic acid, glycolic acid, succinic acid, glutaric acid and/or adipic acid, but also mineral acids, in particular sulfuric acid or alkali hydrogen sulfates, or bases, in particular ammonium or alkali hydroxides. Such pH regulators are contained in the washing and cleaning compositions according to the invention preferably not more than about 10% by weight and particularly preferred from about 0.5 to about 6% by weight, based in each case on the total weight of the composition.

The organic solvents which can be used in the detergents and cleaning agents according to the invention include alcohols with 1 to 4 carbon atoms, in particular methanol, ethanol, isopropanol and tert.-butanol, diols with 2 to 4 C atoms, in particular ethylene glycol and propylene glycol, as well as mixtures thereof and the ethers derivable from the aforementioned compound classes. Such water-miscible solvents are preferably present in the washing and cleaning compositions according to the invention comprising an amount not exceeding about 20% by weight and particularly preferably from about 1 to about 15% by weight.

If the washing and cleaning compositions according to the invention foam too much during use, for example in the presence of anionic surfactants, up to about 6% by weight, preferably about 0.5 to about 4% by weight, of a foam-suppressing agent can be added to them, preferably selected from the group of silicone oils, mixtures of silicone oil and hydrophobized silica, paraffines, paraffin-alcohol combinations, hydrophobized silica, bis-fatty acid amides and other known commercially available defoamers.

The washing and cleaning compositions according to the invention may contain as further ingredients, for example, sequestering agents known from the prior art for such compositions, electrolytes, additional peroxygen activators, colorants or fragrances, such as perfume oils.

The production of the solid or powdery washing and cleaning compositions according to the invention presents no difficulties and can in principle be carried out in a known manner, for example by spray drying or granulation, whereby peroxygen compound A) and co-granules B) are added separately later if necessary.

Washing and cleaning compositions according to the invention in the form of aqueous solutions or solutions containing other conventional solvents can be prepared particularly advantageously by simply mixing the ingredients, which can be added in substance or as a solution in an automatic mixer.

The washing and cleaning compositions according to the invention are preferably in the form of powdery, granular or tablet-like preparations which can be prepared in a manner known per se, for example by mixing, granulating, roller-compacting and/or by spray-drying thermally loadable components and admixing the more sensitive components, which include in particular enzymes, bleaching agents and the bleaching catalyst.

Washing and cleaning agents according to the invention can be used both for hand washing and in household washing machines as well as in commercial washing machines. They can be added by hand or by means of suitable dosing devices. The application concentrations in the cleaning liquor comprise about 1 to about 8 g/l, preferably about 2 to about 5 g/l.

When carrying out a process for washing textiles or cleaning surfaces, the textiles or surfaces are exposed to a washing liquor which has been prepared by adding a washing and cleaning agent containing the components A) and B) described above to water.

Washing and cleaning compositions according to the invention containing components A) and B) can advantageously be used at low temperatures and show excellent washing and cleaning results at temperatures of 40° C. or below, preferably of less than 30° C. and most preferably of less than 25° C. In addition, these washing and cleaning agents also have an excellent germicidal effect at low temperatures. The number of bacteria and yeasts on the substrates treated with these agents is significantly reduced by these agents.

The invention also relates to the use of a washing or cleaning agent containing the components A) and B) described above for disinfecting textiles or surfaces.

Finally, the invention relates to the use of the washing or cleaning composition described above for washing textiles or cleaning surfaces, in particular at temperatures of 40° C. and below.

### EXAMPLES

The following examples are intended to illustrate the invention without limiting it.

### Examples 1 to 5: Production of Coated Co-Granules

The procedure for manufacturing the co-granules in examples 1˜4 was as follows: A binder solution of water, polyvinyl alcohol and citric acid was homogenized for two hours. Subsequently, sulfonimine, bleach activator and desiccant (examples 1 and 2) or sulfonimine, bleach activator, desiccant and dye (examples 3, 4 and 5) were added to an Eirich EL01 intensive mixer, sprayed with the binder solution and processed into granules. The granules were dried in a Retsch TG 200 rapid dryer at 60° C. for 40 minutes and then sieved on a Retsch AS 200 sieve shaker. The fraction from 400 μm to 1200 μm was isolated and sieved. Subsequently, this fraction was coated in a fluidized bed coating device from Glatt. Quantities and components of the compositions used to produce the granules in examples 1-4 are shown in Table 1 below.

The procedure for manufacturing the co-granules of example 5 was as follows: A binder solution of water, polyvinyl alcohol, citric acid and dye was prepared by dissolving the components. Subsequently, sulfonimine, bleach activator and desiccant were added to an Eirich EL01 intensive mixer and premixed. The binder solution was added manually within four minutes and then mixed for two minutes. The resulting granule was dried in a Retsch TG 200 rapid dryer at 60° C. for 45 minutes and then sieved on a Retsch AS 200 sieve shaker. The fraction from 400 μm to 1200 μm was isolated and sieved. Subsequently, this fraction was coated in a fluidized bed coating device from Glatt. Quantities and components of the compositions used to produce the granules of Example 5 are shown in Table 1 below.

TABLE 1
Substances used for the manufacture
of co-granules of examples 1 to 5

| Example No. | 1 | 2 | 3 | 4 | 5 |
|---|---|---|---|---|---|
| 3-methyl-1,2-benzisothiazol-1,1- | 28.5 | 28.5 | 28.45 | 28.45 | 28.45 |
| dioxide (weight %) | | | | | |
| TAED (weight %) | 35.5 | 35.5 | 35.5 | 35.5 | 35.5 |
| polyvinylalcohol (weight %)¹⁾ | 3.8 | 3.8 | 3.8 | 3.8 | 3.8 |
| citric acid (weight %) | 0.4 | 0.4 | 0.4 | 0.4 | 0.4 |
| calcium sulfate-dihydrate (weight | 16.6 | 16.6 | 16.6 | 16.6 | 16.6 |
| % | | | | | |
| dye (weight %) ²⁾ | — | — | 0.05 | 0.05 | 0.05 |
| water (weight %) | 15.2 | 15.2 | 15.2 | 15.2 | 15.2 |

¹⁾In examples 1 and 3 the product Solvadis EP 05 from Solvadis was used; in examples 2 and 4 the product Selvol E205 from Sekisui was used; in example 5 the product Poval 6-88 from Kuraray was used
²⁾ Liquitint AMC from Milliken in examples 3 and 4; Cosmenyl Carmin OC 100 from Heubach in example 5

Stable co-granules could be produced by wet granulation from the formulations of examples 1 to 5.

The co-granules produced according to examples 1 to 5 were then coated in a fluidized bed coating device from Glatt. The fraction in the fluidized bed was coated with a 0.025 wt. % aqueous solution of Tylose® MH 50 G4 (methyl hydroxyethyl cellulose) for four hours.

### Examples 6 and 7: Production of Uncoated Co-Granules

For the production of the co-granules of example 6, the procedure described for the production of the co-granules of examples 1-4 was followed. The coating of the co-granules of example 6 was omitted.

For the production of the co-granules of example 7, the procedure was as described for the production of the co-granules of example 5. The coating of the co-granules of example 7 was omitted.

The quantities and components of the composition used to produce the granules of Examples 6 and 7 are shown in Table 2 below.

TABLE 2
Substances used to produce the co-granules of examples 6 and 7

| Example No. | 6 | 7 |
|---|---|---|
| 3-methyl-1,2-benzisothiazol-1,1- | 28.45 | 28.45 |
| dioxide (weight %) | | |
| TAED (weight %) | 35.5 | 35.5 |
| polyvinylalcohol (weight %)³⁾ | 3.8 | 3.8 |
| citric acid (weight %) | 0.4 | 0.4 |
| calcium sulfate-dihydrate (weight %) | 16.6 | 16.6 |
| dye (weight %) ⁴⁾ | 0.05 | 0.05 |
| water (weight %) | 15.2 | 15.2 |

³⁾For example 6, the product Selvol E205 from Sekisui was used; for example 7, the product Poval 6-88 from Kuraray was used.
⁴⁾ For example 6, Liquitint AMC from Milliken was used; for example 7, Cosmenyl Carmin OC from Heubach was used

Stable co-granules could be produced by wet granulation from the formulations of examples 6 and 7.

### Application Examples—Storage Tests

### Example A1: Storage Tests of the Co-Granules of Examples 1-4

To test the chemical and physical stability of the coated white and pink co-granules of examples 1 to 4, their storage behavior was tested in a commercially available Vanish® formulation from Germany. For this purpose, 3% by weight of these co-granules were incorporated into the Vanish® powder mixture. The mixture was transferred to a glass bottle and stored with the lid closed at 40° C. for three months. It was then visually assessed whether the co-granules had discolored.

It was found that the co-granules of examples 1 to 4 had not changed color during storage. These co-granules were stable in shape and color and did not bleed.

### Example A2: Storage Tests of the Co-Granules of Example 5

To test the chemical and physical stability of the coated pink co-granules of Example 5, their storage behavior was tested in a commercially available Vanish® formulation from Germany. For this purpose, 3% by weight of these co-granules were incorporated into the Vanish® powder mixture. The mixture was transferred to a glass bottle and stored with the lid closed at 40° C. for 48 hours. It was then visually assessed whether the co-granules had discolored.

It was found that the co-granules of example 5 had not changed color during storage. These co-granules were stable in shape and color and did not bleed.

### Example A3: Disaster Test of the Co-Granules of Example 5

0.67 g of the co-granules from example 5 were weighed into a glass bottle. The contents of the bottle were sprayed with 0.2 g of water. The moist granules were mixed using a glass rod and stored in a drying cabinet at 40° C. for 48 hours. Afterwards, it was visually assessed whether the co-granules had changed color.

The co-granules in the bottle showed a slight discoloration.

### Application Examples—Washing Tests

### Examples B1-B4

Lini tests for BC-4 curry staining were carried out at 40° C. wash temperature with the co-granules of examples 1, 2, 5 and 6. 200 ml beakers were filled with one BC-4 cloth rag from CFT B.V. (Center for Test Materials), which was soiled with curry. Then 200 ml of water with a water hardness of 15 dH and a powder mixture were added, resulting in a detergent concentration of 5 g/L. Quantities and compositions of the individual powder mixtures are shown in Table 3 below. After sealing, the beakers were shaken in a water bath at 40° C. for 30 minutes. After drying, the cloth rags were measured with the Elrepho reflectometer (Elrepho 450, Datacolor; XLAV measuring aperture, Ø 34 mm; 400 nm edge filter). The difference in reflectance at λ=457 nm between the unwashed sample and the washed sample was given as ΔR. Results are also shown in Table 3.

TABLE 3
Washing powder formulations and results

| | | sodium | | Co-granule | |
|---|---|---|---|---|---|
| | IEC-A-base- | per- | | according | |
| Example | detergent | carbonate | Peractive ® | to Example | |
| No. | (g) | (g) | P TAED (g) | (g) | ΔR |
| B1 | 1 | 0.15 | 0.03 | 1 (0.01) | 17.4 |
| B2 | 1 | 0.15 | 0.03 | 2 (0.01) | 17.5 |
| B3 | 1 | 0.15 | 0.03 | 5 (0.01) | 17.4 |
| B4 | 1 | 0.15 | 0.03 | 6 (0.01) | 17.6 |

All co-granules used showed a comparable bleaching performance on curry as a hydrophobic soiling.

1. Coated or uncoated co-granules comprising
a) about 10 to about 40% by weight of cyclic sulfonimine,
b) about 20 to about 60% by weight of bleach activator selected from the group consisting of tetraacetylethylenediamine, decanoyloxybenzoic acid and mixtures thereof,
c) about 0.1 to about 5% by weight of organic acid in the form of the free acid and/or a salt thereof,
d) about 1 to about 15% by weight of polyvinyl alcohol as a binder,
e) about 10 to about 25% by weight of desiccant selected from the group consisting of alkali metal sulfate, alkali metal carbonate, alkaline earth metal sulfate, alkaline earth metal carbonate, alkaline earth metal oxide, aluminum oxide, hydrates of these compounds and mixtures of two or more thereof,
f) about 0 to about 0.5% by weight of dye and/or pigment, and
g) about 0 to about 5% by weight of water,
wherein the percentages relate to the sum of components a) to g) and the sum of components a) to g) is 100 percent.

2. Co-granules according to claim 1, wherein tetraacetylethylenediamine is used as bleach activator b).

3. Co-granules according to claim 1, wherein the cyclic sulfonimine a) is a compound of the formula I 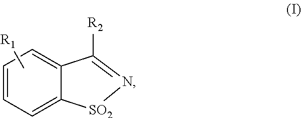
wherein R₁ and R₂ are selected from the group consisting of hydrogen, C₁-C₆-alkyl and phenyl.

4. Co-granules according to claim 3, wherein R₁ is hydrogen and R₂ is C₁-C₆-alkyl or phenyl.

5. Co-granules according to claim 1, wherein the binder d) is a polyvinyl alcohol with a degree of saponification of about 70 to about 100 mol %, which has a viscosity of 2 to 60 mPa*s as a 4% aqueous solution at 25° C., as measured with a Höppler viscometer.

6. Co-granules according to claim 1 wherein the desicant e) is selected from the group consisting of sodium sulfate, magnesium sulfate, calcium sulfate, hydrates of these compounds or mixtures of two or three thereof.

7. Co-granules according to claim 6, wherein the desiccant e) is calcium sulfate dihydrate.

8. Co-granules according to claim 1 wherein the organic acid is c) citric acid and/or one of its alkali metal salts.

9. Co-granules according to claim 1 wherein ingredient g) is absent.

10. Co-granules according to claim 1 comprising the amount of component a) is 25 to 35% by weight, of component b) is 30 to 40% by weight, of component c) is 0.3 to 0.5% by weight, of component d) is 2 to 4% by weight, of component e) is 15 to 20% by weight, of component f) is 0.03 to 0.07% by weight, and of component g) is 0 to 1% by weight.

11. Co-granules according to claim 1 wherein the co-granules are coated with an organic compound with film-forming properties.

12. A washing and cleaning agent comprising
A) bleaching agent selected from the group consisting of perborates, percarbonates and mixtures thereof, and
B) co-granules according claim 1.

13. The washing and cleaning agent according to claim 12, wherein the bleaching agent A) is sodium percarbonate.

14. The washing and cleaning agent according to claim 12 wherein the co-granules B) are coated with cellulose ether.

15. The washing and cleaning agent according to claim 12 as a powder or tablet-like solid.

16. The process of using the washing or cleaning agent according to claim 12 for disinfecting textiles or surfaces.

17. The process of using the washing or cleaning agent according to claim 12 for washing textiles or for cleaning surfaces at temperatures of 40° C. or below.

18. Co-granules according to claim 11 wherein the co-granules are coated with cellulose ether.

19. Co-granules according to claim 18 coated with hydroxyethylmethylcellulose or hydroxypropylmethylcellulose.
